(19) United States
(12) Patent Application Publication
(10) Pub. No.: US 2003/0159067 A1
(43) Pub. Date: Aug. 21, 2003

(54) Method and apparatus for granting access by a portable phone to multimedia services

(75) Inventor: Vlad Alexandru Stirbu, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: NOKIA CORPORATION

(21) Appl. No.: 10/082,534

(22) Filed: Feb. 21, 2002

(51) Int. Cl. H04L 9/00

(52) U.S. Cl. 713/201; 380/247; 713/168

(57) ABSTRACT

An enhanced IMS AKA (21) that allows a UE to register with IMS for all multimedia applications to which it is subscribed. Some of the message content of some of the IMS AKA messages (22) per TS 3GPP 33.203 v 1.0.0 is augmented, and in particular, the message content of CM2 is augmented to include a list of all services to which the UE is subscribed along with either information that allows establishing SAs for each service or information that could be used as keying material or other input for other security mechanisms specific to each service.

### TECHNICAL FIELD

The present invention relates to providing security for access to services offered via a digital communication system (i.e. preventing fraud and protecting information access, integrity, and confidentiality) and more particularly, to regulating access to multimedia services made available via 3G RAN and packet core infrastructures.

### BACKGROUND ART

According to Third Generation Partnership Project (3GPP) Technical Specification (TS) 33.203 V1.0.0 (Access Security for IP-based Services), the IMS (i.e. Internet Protocol (IP) Multimedia Core Network Subsystem or IP Multimedia Subsystem) in UMTS supports IP Multimedia applications such as conferencing using audio, video, and multimedia. 3GPP has chosen Session Initiation Protocol (SIP) as the signaling protocol for creating and terminating Multimedia sessions. TS 33.203 deals only with how SIP signaling is protected, how a subscriber is authenticated, and how a subscriber authenticates the IMS. (Every operator and even third parties can provide IMS services; thus not only is it necessary to authenticate that a UE (user equipment) is a subscriber, but it is also necessary to determine/authenticate the provider of IMS services to which the UE is a subscriber.)

According to the prior art as set out in TS 33.203, authentication (with an IM Services Identity Module, i.e. ISIM) is specified only for one particular application, namely SIP signaling. What is needed is a single, unified authentication and key agreement (AKA) protocol enabling ISIM authentication to the IMS for all applications provided by IMS, not only SIP signaling, independent of the different applications, eliminating the need to design a new security protocol specifically for each new application.

### DISCLOSURE OF THE INVENTION

Accordingly, in a first aspect of the invention, a method is provided for registering a user equipment (UE) with an Internet Protocol (IP) Multimedia Core Network Subsystem or IP Multimedia Subsystem (IMS) so as to allow the UE to access, over a digital communication system, an IP Multimedia (IM) service to which the UE is subscribed, the method including a step in which a serving call session control function (S-CSCF) of the IMS sends an authentication vector (AV) request message to a Home Subscriber Server (HSS), the method characterized in that it includes a step in which in response to the AV request message, the HSS provides in an AV request response message a field indicating a list of substantially all services to which the UE is subscribed along with either information that allows establishing security associations (SAs) for each such service or information that could be used as keying material or other input for other security mechanisms specific to each service.

In accord with the first aspect of the invention, in responding to the AV request response message, the S-CSCF of the IMS may add the information included in the AV request response message to an authorization challenge message and may then forward it to an interrogating CSCF (I-CSCF) of the IMS. Further, when the I-CSCF receives the authorization challenge message, it may forward it as a forwarded authorization challenge message to a proxy CSCF (P-CSCF) of the IMS, which may then parse the forwarded authorization challenge message, generate security policy database (SPD) entries and corresponding SAs for both P-CSCF and UE, insert its SPD entries in its SPD and corresponding SAs into its SA database (SADB), and provide in an updated authorization challenge message for the UE the SPD entries and corresponding SAs. Further, after receiving the updated authorization challenge message, the UE may insert the SPD entries into its SPD and may insert the corresponding SAs into its SADB. Further still, a register may be kept for all services to allocate numbers used to derive keys for each service or part of a service, and the keys may be an integrity key (IK) and a cipher key (CK) and may be derived by applying a practically uni-directional mapping to an argument including the number allocated to the respective service or part of a service by the register being kept.

In a second aspect of the invention, a method is provided for registering a UE with an IMS so as to allow the UE to access, over a digital communication system, an IM service to which the UE is subscribed, the method including a step in which a P-CSCF of the IMS communicates to the UE an authorization challenge message, characterized in that the authorization challenge message includes at least one SPD entry and a corresponding SA derived by the P-CSCF from information provided to the P-CSCF indicating substantially all services to which the UE is subscribed along with either information that allows establishing SAs for each such service or information that could be used as keying material or other input for other security mechanisms specific to each service, and the UE inserts the at least one SPD entry into its SPD and the corresponding SA into its SADB, so that for a predetermined time any traffic between the UE and the P-CSCF is secure for the substantially all services to which the UE is subscribed.

In accord with the second aspect of the invention, a register may be kept for all services to allocate numbers used to derive keys for each service or part of a service. Further, the keys may be an integrity key and a cipher key and may be derived by applying a practically uni-directional mapping to an argument including the number allocated to the respective service or part of a service by the register being kept.

In a third aspect of the invention, a UE is provided, characterized in that it is operative according to the second aspect of the invention.

In a fourth aspect of the invention, a digital communication system having an IMS is provided, characterized in that the IMS is operative according to the first aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram indicating the architecture of the IMS, and showing interfaces with a UE, according to the prior art;

FIG. 2 is a messaging sequence diagram for IMS authentication and key agreement (AKA) for an unregistered IP Multimedia (IM) subscriber (and successful mutual authentication with no synchronization error), according to the prior art (where the message sequence is according to what is called IMS Authentication and Key Agreement (IMS AKA)) and also according to the invention (where the sequence is per what is here called enhanced IMS AKA), the invention including additional information in some of the messages compared to the prior art.

FIG. 3 is a flowchart indicating the steps of the invention (enhanced IMS AKA), which are in addition to the steps for providing IMS authentication and key agreement according to the prior art (IMS AKA).

### BEST MODE FOR CARRYING OUT THE INVENTION

The invention is an enhancement to an existing procedure, called IMS Authentication and Key Agreement (IMS AKA), used to register a UE with IMS. The invention is here referred to as enhanced IMS AKA. Before describing the invention, some background information on IMS is given, by way of context, and next, the IMS AKA procedure is described. Then the invention, enhanced IMS AKA, is presented by describing how it augments the IMS AKA procedure (by augmenting the content of some of the messages).

Background on IMS

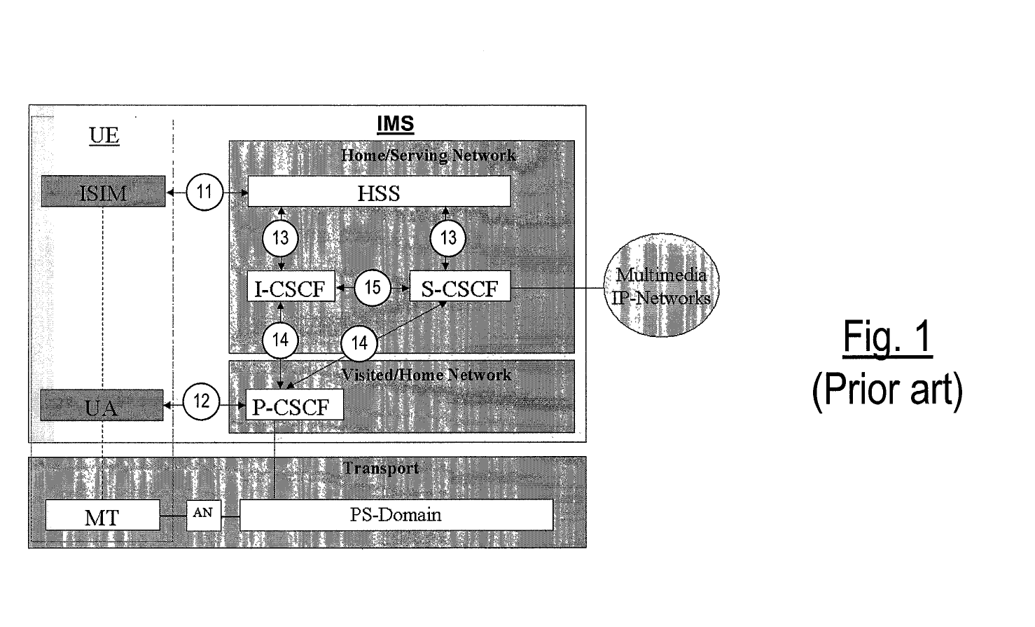

IMS includes all core network (CN) elements for provision of IP Multimedia (IM) services. The IMS security architecture according to TS 33.203 is illustrated in FIG. 1. As shown in FIG. 1, the IMS includes various instances of a Call Session Control Function (CSCF) (i.e. a proxy CSCF (P-CSCF), an interrogating CSCF (I-CSCF), and a serving CSCF (S-CSCF)) as well as a Home Subscriber Server (HSS). The HSS is the master database for a given user; it is the entity containing the subscription-related information to support the network entities actually handling calls/sessions.

In the PS domain, service is not provided to a UE by a 3G wireless communication network until a security association is established by IMS between the UE and the network. (IMS is designed to be access network independent, and so it should be possible to access the IMS over either a wired or a wireless communication system.) IMS is essentially an overlay on the PS domain with a low dependency on the PS domain, i.e. IMS operates essentially independent of what is occurring in the PS domain; consequently, a separate security association (i.e. separate from the security association granting access to the PS domain) is required between a multimedia client and the IMS before access is granted to multimedia services.

The ISIM is responsible for keys, sequence numbers (SQNs), and other similar objects/parameters tailored to the IMS. The security parameters handled by an ISIM are independent of corresponding security parameters for a User Services Identity Module (USIM).

IMS includes an CSCF that can act as either proxy CSCF, in which case it is called a P-CSCF, or a serving CSCF, in which case it is called a S-CSCF, or an interrogating CSCF, in which case it is called an I-CSCF. The P-CSCF is characterized by being the first contact point for the UE within the IMS; the S-CSCF actually handles the session states in the network; the I-CSCF is mainly the contact point within an operator's network for all IMS.

FIG. 1 shows five different security associations 11-15 relevant in providing security for access to multimedia services by a UE via IMS: a UE ISIM/HSS association 11; a UA (User Agent)/P-CSCF association 12; an HSS/I-CSCF and an HSS/S-CSCF association 13; an I-CSCF/P-CSCF and an S-CSCF/P-CSCF association 14; and an I-CSCF/S-CSCF association 15. The invention is concerned with the two associations 11 and 12 between the UE and the IMS. (FIG. 1 also shows a mobile terminal (MT) connected to a Packet-Switched (PS) domain through an application network (AN).)

According to TS 33.203, an IM subscriber has its subscriber profile located in the HSS in the home network. At registration, an S-CSCF is assigned to the subscriber by the I-CSCF. When the subscriber requests an IM-service, the S-CSCF checks, by matching the request with the subscriber profile, if the subscriber is allowed to continue with the request or not.

The mechanism for registration in UMTS is called UMTS AKA, which is a challenge response (secure) protocol. The corresponding mechanism for multimedia services is called IMS AKA and it uses the same concepts and principles as UMTS AKA: in particular, the home network authenticates a subscriber only via registrations (or re-registrations). IMS AKA provides shared keys for protecting IMS signaling between the UE and the P-CSCF. To protect IMS signaling between the UE and the P-CSCF it is also necessary to agree on a protection method (e.g. an integrity protection method) and a set of parameters specific to the protection method, e.g. the cryptographic algorithm to be used. The parameters negotiated are typically part of what is called a security association (SA) to be used for an agreed on protection mechanism. Although the available protection mechanisms can be quite different, there is a common set of parameters (i.e. an SA) that must be negotiated for each of them. This set of parameters includes: Authentication (integrity) algorithm, and optionally encryption algorithm; SA_ID used to uniquely identify the SA at the receiving side; Key length, i.e. the length of encryption and authentication (integrity) keys, which is usually taken to be 128 bits.

IMS AKA

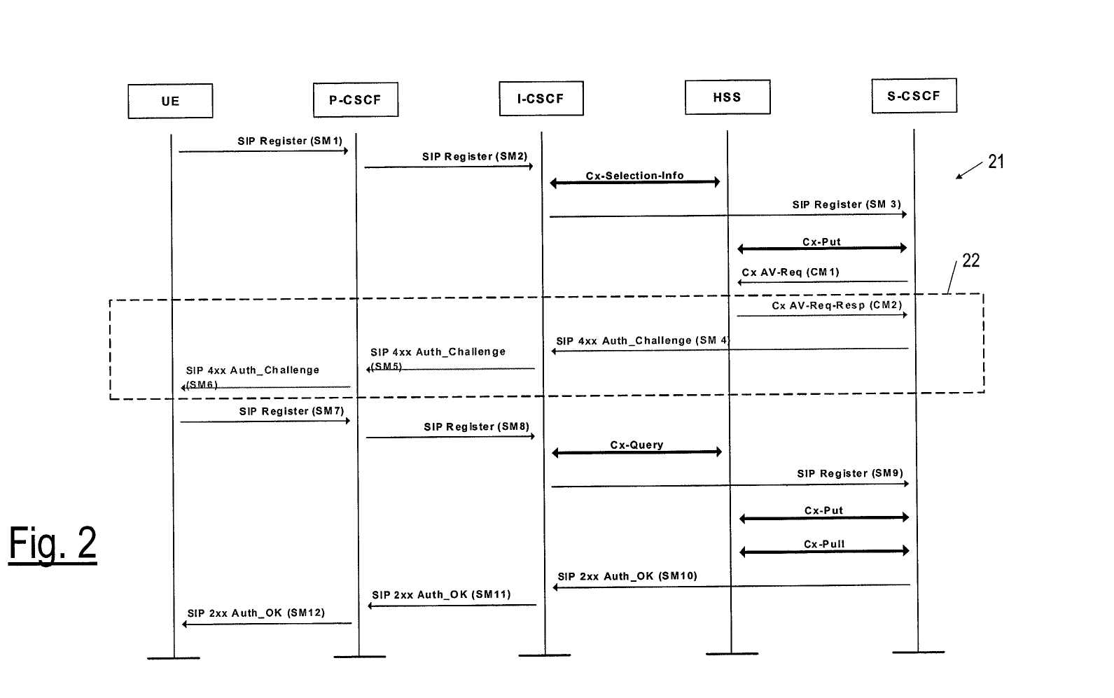

Before a UE can get access to IM services, at least one IM Public Identity (IMPU) must be registered and the IM Private Identity (IMPI) authenticated in the IMS at the application level. As shown in FIG. 2, in order to be registered, the UE sends an SIP REGISTER message SM1 (SIP message 1) to the SIP registrar server, i.e. the S-CSCF, via the P-CSCF and the I-CSCF; the S-CSCF then authenticates the UE. When the P-CSCF and the I-CSCF forward the SIP REGISTER to the S-CSCF as respective messages SM2 and SM3, they include their addresses in the messages.

In order to handle mobile terminated calls while the initial registration is in progress, the S-CSCF sends to the HSS a registration flag (via a Cx-Put), which the HSS stores together with the S-CSCF name. The aim of using a registration flag is to indicate whether a particular IMPU of the UE is unregistered or registered at a particular S-CSCF or if the initial registration at a particular S-CSCF is pending. The HSS receives the information about this state (together with the S-CSCF name and the UE identity) from the S-CSCF with which registration/reregistration of the user is carried out only when a Cx-Put message is sent from the S-CSCF to the HSS. The registration flag is set to initial registration pending at the Cx-Put procedure after message SM3 is received by the S-CSCF.

Upon receiving the SIP REGISTER, the S-CSCF needs one authentication vector (AV) that includes a challenge. As an option, the S-CSCF can require more than one AV. If the S-CSCF has no valid AV, then the S-CSCF sends a request for one or more AVs to the HSS in a message connection (Cx) message 1 (CM1). If the HSS has no pre-computed AVs, the HSS creates the needed AVs for the UE and sends them to the S-CSCF in a message CM2.

The S-CSCF then sends a SIP 4xx Auth_Challenge (an authentication challenge) as a message SM4, intended for the UE, including a random challenge (RAND), an authentication token (AUTN), an integrity key (IK), and, optionally, a cipher key (CK). The SM4 is received by the I-CSCF, which forwards it to the P-CSCF as a message SM5. When the P-CSCF receives the message SM5, it stores the key(s), removes the key information from the message SM5, and forwards the rest of the message to the UE as a message SM6.

Upon receiving the message SM6 (i.e. the challenge), the UE takes the authorization token AUTN, which includes a Message Authentication Code (MAC) and the SQN, calculates the Expected MAC (XMAC), and checks that the XMAC is the same as the MAC and that the SQN is in the correct range (as per TS 33.102). If both checks are successful, the UE calculates the response RES, puts it into the authorization header, and sends it back to the registrar in a message SM7. The UE also computes the session keys CK and IK at this same point in the sequence.

The P-CSCF forwards the response RES to the I-CSCF in a message SM8, which queries the HSS to find the address of the S-CSCF. The I-CSCF forwards the RES to the S-CSCF in a message SM9. Upon receiving the response RES, the S-CSCF retrieves the active expected response (XRES) for the UE and checks if the XRES is the same as RES. If the check is successful, then the UE is deemed authenticated, and the IMPU is registered in the S-CSCF.

At this stage, after receiving the message SM9 and registering the UE (if all checks are successful), the S-CSCF sends in a Cx-Put an update of the registration-flag. If the authentication of the UE is successful, the registration flag takes the value registered; when the authentication is unsuccessful the registration flag is set to unregistered. The authentication is communicated to the UE as a 2xx_Auth_OK message, provided by the S-CSCF to the I-CSCF as a message SM10, which is forwarded to the P-CSCF as a message SM11, which is then finally provided to the UE as a message SM12.

When a UE is registered, the registration is valid for a predetermined period of time. (Both the UE and the S-CSCF keep track of the time on a timer for this purpose, but the expiration time in the UE is smaller than the expiration time in the S-CSCF in order to make it possible for the UE to be registered and to be reachable without interruption.)

The Invention: Enhanced IMS AKA

TS 33.203 v 1.0.0 provides, as annexes, two competing technologies for providing a security mechanism for the UE/P-CSCF association: IP SEC and SIP level. In the best mode, the present invention takes the IP SEC solution presented in TS 33.203 and enhances it. The best mode is described below. It should be understood, however, that the invention is also of use as an enhancement to the SIP level approach to UE/P-CSCF security. One of the benefits of applying the enhanced IMS AKA with the SIP level solution is that doing so provides input (i.e. keying material, meaning master keys, pre-master keys, and so on) for mechanisms that are specific to each service (i.e. to each application providing a respective service).

Thus, in the best mode, as in the prior art, Internet Protocol (IP) security (SEC) Encapsulating Security Payload (ESP) provides integrity and confidentiality between the UE and the P-CSCF, but the procedure by which such security is provided is enhanced. In addition, in the invention as well as in the prior art, the S-CSCF acts as an authentication server for all services provided by the IMS; HSS serves as the master database, maintaining a subscriber profile containing also a list with all the services to which the user is subscribed; and P-CSCF performs as a proxy for all services provided by the IMS.

Referring now to FIG. 2, in the preferred embodiment, the message sequence chart 21 is unchanged from IMS AKA by the invention, but the content of the messages changes with the message CM2. In the preferred embodiment, only the messages enclosed in the box 22 are changed by the invention. Thus, according to the invention, registration of a UE with IMS proceeds as per IMS AKA until message CM2.

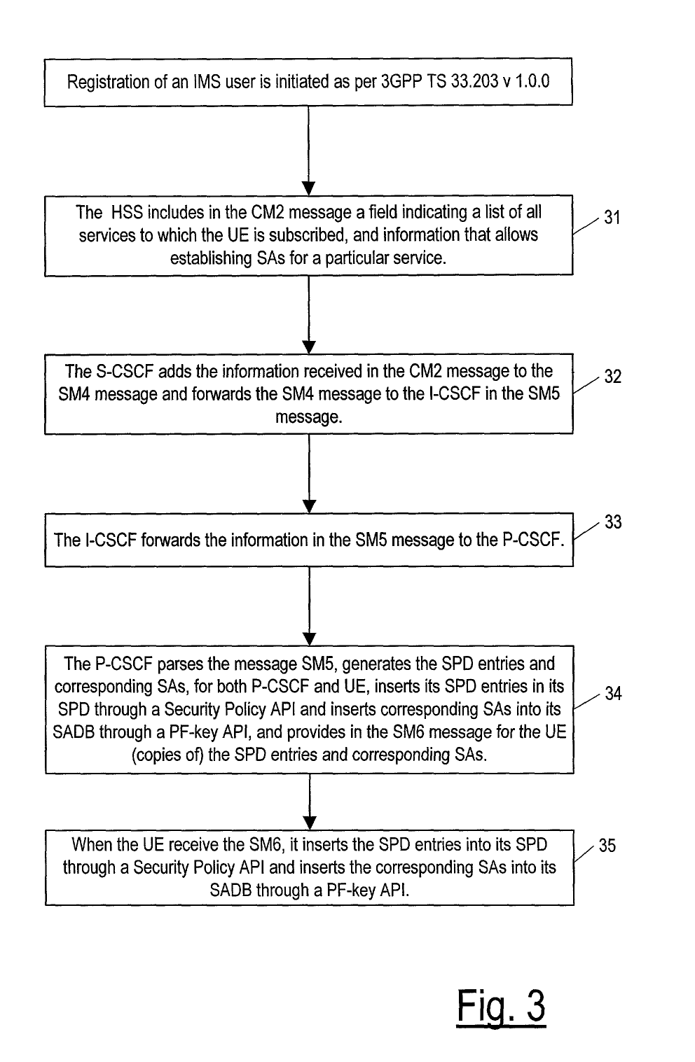

Referring now also to FIG. 3, at the point in the sequence 21 where the CM2 message is constructed, in addition to what is specified in TS 33.203 v1.0.0 for CM2, the message CM2 according to the invention is augmented 31 to contain a field including a list of all services to which the IMS user is subscribed, as well as information that allows establishing SAs for each service, the information including the name of the server, port numbers in case the servers are not listening on standard ports, and so on.

In a step 32, the S-CSCF adds the information received in message CM2 to the message SM4, and forwards SM4 to the I-CSCF which in turn, in a step 33, forwards it in the message SM5 to the appropriate P-CSCF. Once the P-CSCF receives SM5, in a step 34 it parses the information and provides from the parsed information an Security Policy Database (SPD) entry (or entries) (i.e. a policy entry), and inserts the SPD entry (or entries) into its SPD through a “Security Policy API” (API being the acronym for Application Program Interface), which in the Symbian implementation is named Secpol API, but which in other implementations could have other names. The P-CSCF then inserts into its Security Association DataBase (SADB), using a PF-key API (i.e. a Key Management API, Version 2, as set out in RFC 2367 by the Network Working Group of The Internet Society), corresponding SAs, one SA for each policy (one service/application can have one or several policies, depending on the nature/requirements of the exchanged application data). At the same time the P-CSCF generates the SPD entry or entries and corresponding SAs for the UE and adds them to the message SM6 for delivery to the UE. (PF-key is a new socket protocol family used by trusted privileged key management applications to communicate with an operating system's key management internals, referred to as the “Key Engine” or the Security Association Database (SADB). The Key Engine and its structures incorporate the required security attributes for a session and are instances of the “Security Association” (SA) concept described in Atkinson, R., “IP Security Architecture”, RFC 1825 by the Network Working Group of The Internet Society, August 1995.)

It might be possible that P-CSCF generates only its own SPD entries and SAs and adds to the SM6 the information that was received in the SM5. In this case the UE must generate locally its own SPD entries and SAs. (The alternative presented here, although a possibility, is not as flexible as that described above.)

After the UE receives the message SM6, in a step 35 the UE inserts the SPD entries into its SPD through a so-called Security Policy API, and inserts the corresponding SAs in its SADB through a PF-key API; from that point on, the traffic between the UE and the P-CSCF is secure for all services to which the user is subscribed. The rest of the message sequence is the same as described in TS 33.203 v1.0.0 for IMS AKA.

In order to have different keys (IK and CK) for each service, some kind of register should be kept to allocate numbers for the service. The numbers should be used to derive the keys using formulas such as:

IK_{—}app_{—}X=SHA1(IK|X)

CK_{—}app_{—}X=SHA1(CK|X)

where SHA1( ) is the function “Secure Hash Algorithm 1” (according to RFC3174 by the Internet Society) and indicates hashing the indicated argument, i.e. performing a practically uni-directional (practically non-invertible) mapping on the indicated argument, where IK is an integrity key and CK is a cipher key, both of which are derived by standard IMS AKA and are non-application specific, i.e. are general, whereas IK_app_X and CK_app_X are application specific keys, and where X is the number allocated to the respective service/application (or part of a service or application) according to the register being kept. There should be one register for all services, organized essentially as in Table 1 below.

TABLE 1
Register of services.

| Service | Assigned Number |
|---|---|
| SIP Signaling | 0 |
| Presence | 10 |
| Instant Messaging | 11 |

Some services can be complex, including several different parts or component services, but are nevertheless identified as single (combined) services. Thus, in providing such a service, several parts of services (i.e. component services) are provided. In Table 1, Presence and Instant Messaging appear in the register as different services, but they are actually provided as parts of a single, combined service referred to as Presence, Messaging and Groups. The two parts of services could need different keys because for example, for Presence, integrity and confidentiality might be needed (requiring the integrity key and the cipher key), but for Instant Messaging, only integrity might be needed.

There are several options/alternatives as to what entity should maintain/keep the register. One option is that 3GPP should keep the register in the same way Internet Assigned Numbers Authority (IANA) keeps a register of assigned port numbers, as described in RFC 1060. Another option is that operators keep their own register. Regardless of which entity keeps the register, it must exist before any AKA sequence is started. One practical representation of this register could be a configuration file similar to the /etc/services file found on most Unix machines; the file services is usually found in the/etc directory on a Unix machine.

It should be noted that the enhanced IMS AKA of the invention does not omit or delete any messages or parts of messages from standard IMS AKA according to TS 33.203 v1.0.0. Also, authentication failures and errors in setting up SAs should be treated as specified in TS 33.203 v1.0.0.

The invention is practiced by a digital communication system and a UE communicating via such a communication system. The UE can be any of several kinds. In TS 33.203, the UE is a mobile terminal MT (cellular phone). However, other kinds of UEs can advantageously practice the invention as well, including UEs without an integral MT component, but attached to an external MT, such as a laptop computer attached to a MT or to a mobile router, or other devices that communicate with a MT. It is important to understand that the list of devices given here is not intended to be exhaustive. In addition, some devices will not implement the complete functionality provided by the invention, but will support only a few services/applications provided by the IMS.

With respect to the digital communication system in which the invention may be practiced, in TS 33.203, the communication system is the UMTS Release 5 network; however, it is clear from what has been described that the invention is also of use in other communication systems besides the UMTS Release 5 network. In particular, any third party could implement a system that is operative according to the invention. For example, the communication system could even be the Internet, and the UE could be connected to the Internet via either a wireless or a wireline connection not involving some other communication system (e.g. the connection is a simple connection to the Internet via an Internet Service Provider) or via an intermediate communication system (e.g. a mobile phone connected to the Internet via UTRAN, i.e. UMTS (Universal Mobile Telecommunications System) Terrestrial Radio Access Network).

Scope of the Invention

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method for registering a UE with an IMS so as to allow the UE to access, over a digital communication system, an IM service to which the UE is subscribed, the method including a step in which an S-CSCF of the IMS sends an AV request message (CM1) to an HSS, the method characterized in that it includes a step in which in response to the AV request message (CM1), the HSS provides (31) in a AV request response message (CM2) a field indicating a list of substantially all services to which the UE is subscribed along with either information that allows establishing SAs for each such service or information that could be used as keying material or other input for other security mechanisms specific to each service.

2. The method as in claim 1, further characterized in that in responding to the AV request response message (CM2), the S-CSCF of the IMS adds (32) the information included in the AV request response message (CM2) to an authorization challenge message (SM4) and forwards it to an I-CSCF of the IMS.

3. The method as in claim 2, further characterized in that when the I-CSCF receives the authorization challenge message (SM4), it forwards (33) it as a forwarded authorization challenge message (SM5) to a P-CSCF of the IMS, which parses (34) the forwarded authorization challenge message (SM5), generates SPD entries and corresponding SAs for both P-CSCF and UE, inserts its SPD entries in its SPD and corresponding SAs into its SADB, and provides in an updated authorization challenge message (SM6) for the UE the SPD entries and corresponding SAs.

4. The method as in claim 3, further characterized in that after receiving the updated authorization challenge message (SM6), the UE inserts (35) the SPD entries into its SPD and inserts the corresponding SAs into its SADB.

5. The method as in claim 4, further characterized in that a register is kept for all services to allocate numbers used to derive keys for each service or part of a service.

6. The method as in claim 5, further characterized in that the keys are an integrity key and a cipher key and are derived by applying a practically uni-directional mapping to an argument including the number allocated to the respective service or part of a service by the register being kept.

7. A method for registering a UE with an IMS so as to allow the UE to access, over a digital communication system, an IM service to which the UE is subscribed, the method including a step in which a P-CSCF of the IMS communicates to the UE an authorization challenge message (SM6), characterized in that the authorization challenge message (SM6) includes at least one SPD entry and a corresponding SA derived by the P-CSCF from information provided to the P-CSCF indicating substantially all services to which the UE is subscribed along with either information that allows establishing SAs for each such service or information that could be used as keying material or other input for other security mechanisms specific to each service, and the UE inserts (35) the at least one SPD entry into its SPD and the corresponding SA into its SADB, so that for a predetermined time any traffic between the UE and the P-CSCF is secure for the substantially all services to which the UE is subscribed.

8. The method as in claim 7, further characterized in that a register is kept for all services to allocate numbers used to derive keys for each service or part of a service.

9. The method as in claim 8, further characterized in that the keys are an integrity key and a cipher key and are derived by applying a practically uni-directional mapping to an argument including the number allocated to the respective service or part of a service by the register being kept.

10. A UE, characterized in that it is operative according to the method of claim 7.

11. A digital communication system having an IMS, characterized in that the IMS is operative according to the method of claim 1.
